(19) United States
(12) Patent Application Publication
(10) Pub. No.: US 2006/0093174 A1
(43) Pub. Date: May 4, 2006

(54) Hearing aid

(75) Inventors: Torsten Niederdrank, Erlangen (DE); Peter Nikles, Erlangen (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Audiologische Technik GmbH

(21) Appl. No.: 11/254,966

(22) Filed: Oct. 20, 2005

(30) Foreign Application Priority Data
Oct. 20, 2004 (DE) 10 2004 051 226.4

(51) Int. Cl. H04R 25/00

(52) U.S. Cl. 381/317; 381/312

(57) ABSTRACT

It is intended with a hearing aid that an electromagnetic interference field generated in the hearing aid device itself and acting on a transmit and/or receive antenna (7) should be attenuated or compensated for in a simple fashion. It is proposed to this end that the supply lines (6C, 6D) of the hearing aid device (1) should be used to position loops (8, 9) specifically, so that an opposing field is generated to attenuate or compensate for the interference fields present at the site of the transmit and/or receive antenna (7).

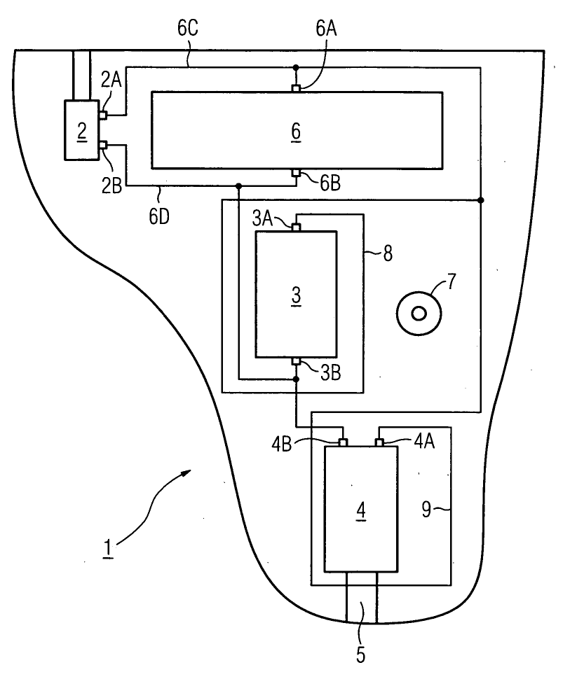

The invention relates to a hearing aid device with hearing aid device components, such as an input converter for detecting an input signal and converting it to an electric signal, a signal processing unit for processing and amplifying the electric signal and an output converter for emitting an output signal that can be perceived by the user as an acoustic signal and with a voltage source for supplying voltage to the hearing aid device components, with supply lines being present between the voltage source and the hearing aid device components to be supplied.

When inductive transmission systems are used in hearing aid devices, it is necessary to minimize the influence of internal interference, i.e. interference generated in the hearing aid device itself. Electromagnetic interference signals generated within the hearing aid device load the receive path of the transmission system, so that only those external signals with a signal strength greater than the signal strength of the interference signals can be received. Typical sources of electromagnetic interference signals are the earpiece, which is generally configured as a magnetic converter and emits powerful inductive interference signals. The supply lines to said earpiece are also worthy of mention, as are the various connecting lines to the electronic system of the hearing device, which must be seen as inductive antennae due to the flow of current through said lines. The electronic system of the hearing device itself also imitates electromagnetic interference signals and must therefore be considered to be a source of interference signals. The superimposition of these numerous electromagnetic interference signals emitted by the various interference signal sources is received at the site of a receive antenna or a receive coil of a transmission system for wireless signal transmission, which uses the inductive range or even the typical RF range.

A hearing device with an auditory coil for the inductive detection of signals is known from DE 197 12 236 C1. To minimize the auditory coil distortion factor, it is proposed that compensatory inductivity, e.g. a compensatory SMD coil, be deployed parallel or anti-parallel to the auditory coil to generate a compensatory field.

The object of the present invention is to minimize the influence of electromagnetic interference produced in the hearing aid device itself on a transmission system for wireless signal transmission by measures that are simple to execute within the hearing device.

This object is achieved with a hearing aid device with hearing aid device components, such as an input converter for detecting an input signal and converting it to an electric signal, a signal processing unit for processing and amplifying the electric signal and an output converter for emitting an output signal that can be perceived by the user as an acoustic signal and with a voltage source for supplying voltage to the hearing aid device components, with supply lines being present between the voltage source and the hearing aid device components to be supplied, in that the supply lines have at least one loop, to attenuate or compensate specifically for an electromagnetic interference field in a defined area within the hearing aid device. In a hearing aid device an input converter detects an input signal and converts it to an electric input signal. Generally at least one microphone serves as an input converter, detecting an acoustic input signal. Modern hearing aid devices frequently have a microphone system with a number of microphones, to achieve a directional characteristic by receiving as a function of the direction of incidence of the acoustic signals. The input converters can however also have a telephone coil or an antenna to detect electromagnetic input signals. The input signals converted by the input converter to electric input signals are fed to a signal processing unit for further processing and amplification. The further processing and amplification take place to equalize the individual hearing loss of a hearing aid device wearer generally as a function of the signal frequency. The signal processing unit emits an electric output signal, which is fed via an output converter to the ear of the hearing aid device wearer, so that said wearer perceives the output signal as an acoustic signal. The output converters are generally earpieces that generate an acoustic output signal. However output converters for generating mechanical vibration are also known, which directly cause defined parts of the ear, e.g. the ossicles, to vibrate. Outputs converters, which directly stimulate the nerve cells of the ear are also known.

Until now it was general practice with hearing aid devices to keep the supply lines supplying voltage to the individual components of the hearing aid device as short as possible, to minimize the emission of electromagnetic interference signals from these lines as far as possible. It is proposed here that we should depart from this standard practice and lengthen the supply lines “artificially” such that these supply lines, through which the supply current flows, generate an opposing field, which compensates for or at least attenuates an electromagnetic interference field at a defined site within the hearing aid device. Compensation or attenuation advantageously takes place at the site where an antenna or induction coil for wireless signal transmission from or to the hearing aid device is located. The opposing fields thus generated can significantly reduce the interference level at the receive antenna or receive coil of a transmission system for wireless signal transmission integrated in the hearing aid device.

The production of additional loops not required purely for contact purposes with the various components of the hearing aid device does not require any additional element to be inserted in the hearing aid device. The production cost for such a hearing air device is therefore only insignificantly higher. The size and orientation of the loops can be varied slightly so that the generated opposing field can be adjusted in a simple fashion in respect of its field strength and orientation. One or more loops are advantageously positioned around a specific element within the hearing aid device, for example a hybrid element, which also simplifies production of the loop. The surface enclosed by the loop, which ultimately defines the strength of the generated opposing field, is also determined relatively precisely as a result.

The invention is described in more detail below with reference to an exemplary embodiment. The figure thereby shows a hearing aid device 1 with a microphone 2 for detecting an acoustic input signal and converting it to an electric signal, which is then fed to a signal processing unit 3 configured as a hybrid element for further processing and amplification. The output signal of the signal processing unit 3 is finally converted to an acoustic signal by means of an earpiece 4 and emitted via an acoustic channel 5 into the auditory canal of a user. The hearing aid device 1 has an antenna 7 for wireless transmission of electromagnetic signals between the hearing aid device 1 and a further device, for example a second hearing aid device of the same design for binaural coverage for the user.

A battery 6 with battery terminals 6A and 6B is provided to supply voltage to the hearing aid device. Supply lines 6C and 6D are present between the battery terminals 6A and 6B and contacts 2A and 2B of the microphone 2, contacts 3A and 3B of the hybrid element 3 and contacts 4A and 4B of the earpiece 4. As can be seen from the schematic illustration, the supply lines do not take the shortest route to the hybrid element 3 or earpiece 4. Instead there is a loop 8 or 9 around the hybrid element 3 and the antenna 7 respectively, so that electromagnetic interference fields resulting from the supply lines 6C, 6D or the elements 3 and 4 are compensated for at the site of the loop 7. This increases the sensitivity of the hearing aid device 1 when receiving electromagnetic signals from external devices.

The figure only shows a schematic, highly simplified exemplary embodiment of the invention. Other geometries and orientations of the loops according to the invention are naturally also within the scope of the invention. The loops 8 and 9 can also have a number of windings. An auditory coil (not shown) can also be present to receive electromagnetic signals instead of the antenna 7.

1.-5. (canceled)

6. A hearing aid, comprising:
an input converter for detecting an input signal and converting the input signal into an electrical signal;
a signal processing unit for processing and amplifying the electrical signal;
an output converter for emitting an acoustic output signal perceivable by a user of the hearing aid; and
a voltage source for supplying a voltage to the input converter, the signal processing unit and the output converter, the voltage source having supply lines arranged within the hearing aid for connecting the voltage source to the input converter, the signal processing unit and the output converter, wherein at least part of the supply lines are formed as a loop for attenuating or compensating for an electromagnetic interference field present in a specific area within the hearing aid.

7. The hearing aid according to claim 6, wherein the loop is arranged around a hybrid component of the hearing aid.

8. The hearing aid according to claim 6, wherein the loop is arranged around an earpiece of the hearing aid.

9. The hearing aid according to claim 6, wherein at least part of the supply lines are formed as a plurality of loops for attenuating or compensating for an electromagnetic interference field present in a plurality of specific areas within the hearing aid.

10. The hearing aid according to claim 6, wherein the specific area is an area adjacent to a transmitting and/or receiving antenna.

11. The hearing aid according to claim 6, wherein the specific area is an area adjacent to a transmitting and/or receiving coil.
